(19) United States
(12) Patent Application Publication
(10) Pub. No.: US 2025/0112427 A1
(43) Pub. Date: Apr. 3, 2025

(54) CABLE CONNECTOR ASSEMBLY

(71) Applicant: FOXCONN INTERCONNECT TEHCNOLOGY LIMITED, Grand Cayman (KY)

(72) Inventors: TING-CUI WANG, Chongqing (CN); Yang-Tsun Hsu, New Taipei (TW); Chun-Chen Lin, New Taipei (TW); Jun Chen, Kunshan (CN); Wen-Qiang Lan, Chongqing (CN); Fei-Fan Jing, Huaian (CN)

(21) Appl. No.: 18/897,800

(22) Filed: Sep. 26, 2024

(30) Foreign Application Priority Data
Sep. 28, 2023 (CN) 202311272575.4

(51) Int. Cl. H01R 24/60; H01R 12/55; H01R 13/6473; H01R 13/66

(52) U.S. Cl. CPC H01R 24/60; H01R 12/55; H01R 13/6473; H01R 13/6691

(57) ABSTRACT

A cable connector assembly includes: a mating plug including plural conductive terminals; a circuit board being electrically connected to the mating plug and including: plural terminal pads located at a front of the circuit board and mechanically and electrically connected to the conductive terminals; plural cable pads located at a rear of the circuit board and including plural pairs of high-speed cable pads; and plural conductive traces each connecting a corresponding terminal pad and a corresponding cable pad; and a cable mechanically and electrically connected to the cable pads; wherein the cable includes plural pairs of high-speed wires for transmitting high-speed signals, the conductive traces include plural pairs of high-speed conductive traces connecting the plural pairs of high-speed cable pads and corresponding terminal pads, each pair of high-speed cable pads are connected to a nearest pair of terminal pads.

### BACKGROUND OF THE INVENTION

### Field of the Invention

The present invention relates generally to a cable connector assembly with high speed signal transmission structure.

### Description of Related Arts

U.S. Pat. No. 10,777,951 discloses a cable connector assembly comprising a mating plug, a circuit board electrically connected to the mating plug, and a cable electrically connected to the circuit board. The circuit board includes a cable conductive pad arranged at the rear side of the circuit board for connecting to the cable, a terminal conductive pad arranged at the front side for connecting to the mating plug, and a conductive trace connecting the cable conductive pad and the terminal conductive pad. The cable includes a pair of high-speed signal wires capable of transmitting high-speed signals. The conductive trace connecting the pair of high-speed signal wires and a corresponding terminal conductive pad on the circuit board is long and curved, which is not conducive to the transmission of high-speed signals.

An improved cable connector assembly is desired.

### SUMMARY OF THE INVENTION

The objective of the present invention is to provide a cable connector assembly capable of transmitting high-speed signals.

To achieve the above object, a cable connector assembly comprises: a mating plug including a plurality of conductive terminals; a circuit board being electrically connected to the mating plug and including: a plurality of terminal pads located at a front of the circuit board and mechanically and electrically connected to the conductive terminals; a plurality of cable pads located at a rear of the circuit board and including plural pairs of high-speed cable pads; and a plurality of conductive traces each connecting a corresponding terminal pad and a corresponding cable pad; and a cable mechanically and electrically connected to the cable pads; wherein the cable includes plural pairs of high-speed wires for transmitting high-speed signals, the conductive traces include plural pairs of high-speed conductive traces connecting the plural pairs of high-speed cable pads and corresponding terminal pads, each pair of high-speed cable pads are connected to a nearest pair of terminal pads.

Compared to prior art, in the cable connector assembly of the present invention, the high-speed cable conductive pads of the present invention are connected to the nearest pair of terminal conductive pads, shortening the length of the high-speed conductive trace, thereby facilitating the transmission of high-speed signals.

### BRIEF DESCRIPTION OF THE DRAWING

FIG. 1 is a perspective view of a cable connector assembly according to the present;

FIG. 2 is a partial exploded view of the cable connector assembly of FIG. 1;

FIG. 3 is a further exploded view of the cable connector assembly of FIG. 2, removing the inner mold and insulating housing;

FIG. 4 is a further exploded view of cable connector assembly of FIG. 3, removing the metal cage;

FIG. 5 is a further exploded view of another view of the cable connector assembly of FIG. 4;

FIG. 6 is a front view of the cable and the circuit board of the cable connector assembly of FIG. 5;

FIG. 7 is a top view of the cable and the circuit board of the cable connector assembly of FIG. 6;

FIG. 8 is a perspective view of cable connector assembly before the cable soldering to circuit board of FIG. 6;

FIG. 9 is another perspective view of the cable and circuit board of the cable connector assembly of FIG. 8;

FIG. 10 is a front view of the circuit board of cable connector assembly of FIG. 8; and

FIG. 11 is a front view of the circuit board of cable connector assembly of FIG. 10.

### DETAILED DESCRIPTION OF THE PREFERRED EMBODIMENT

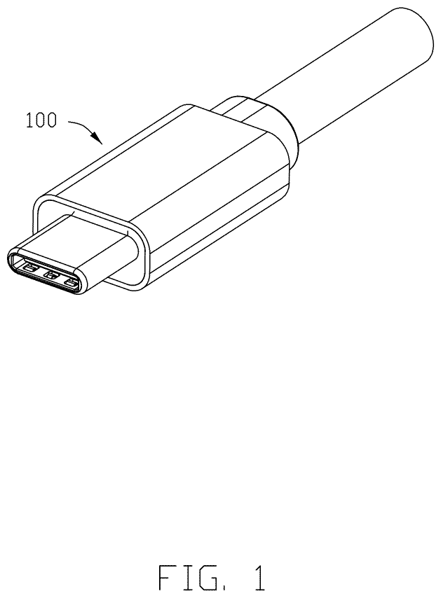

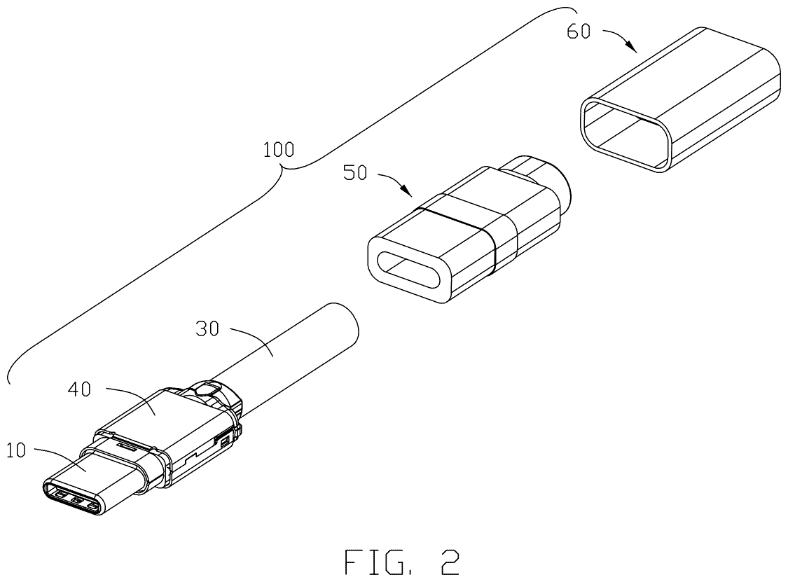

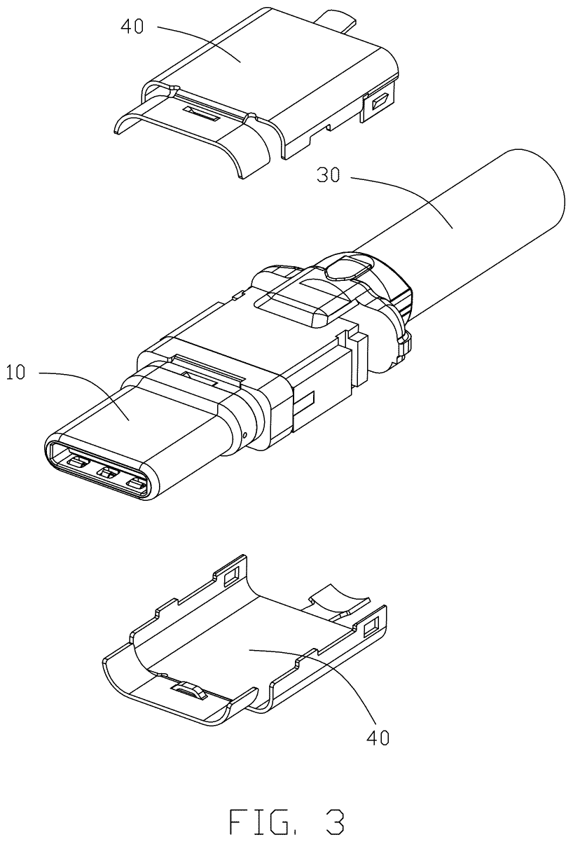

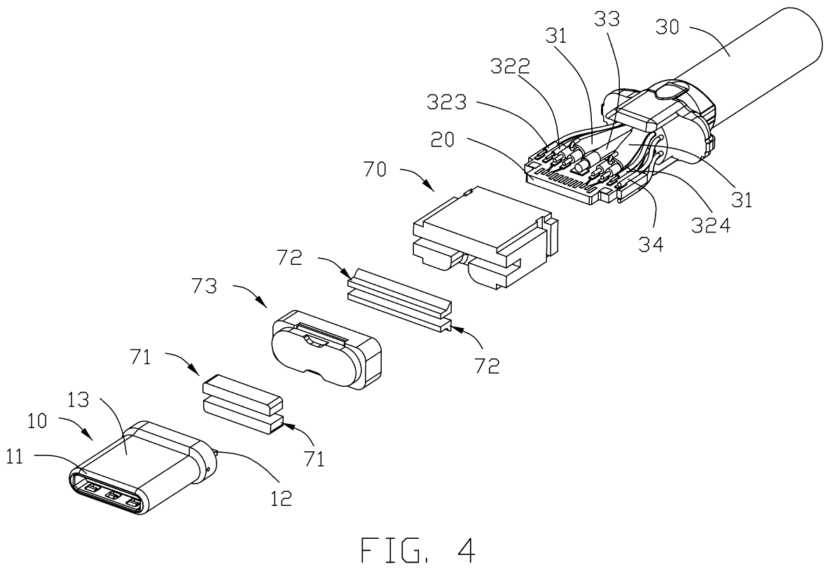

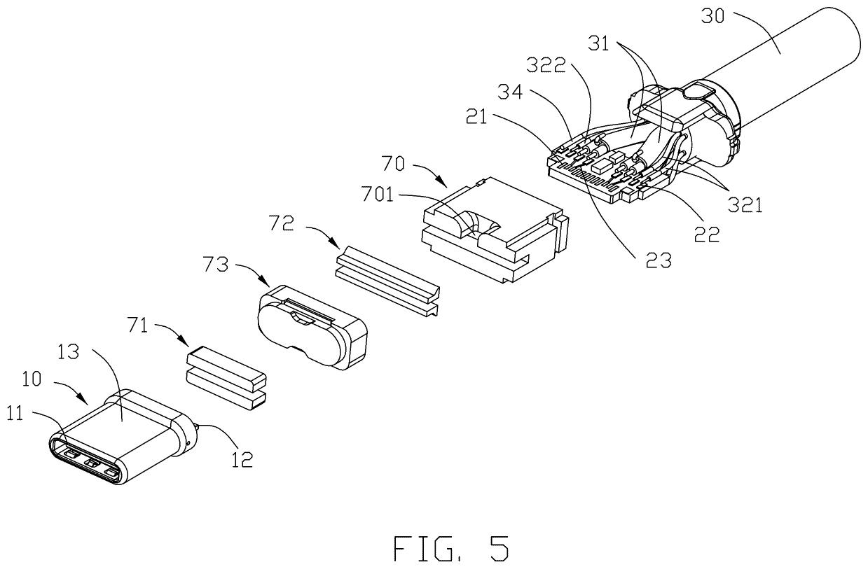

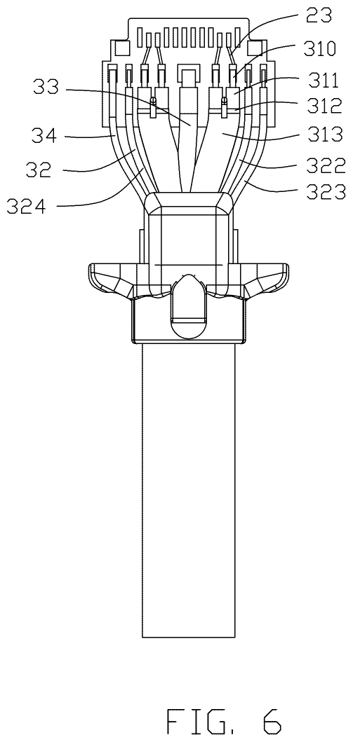

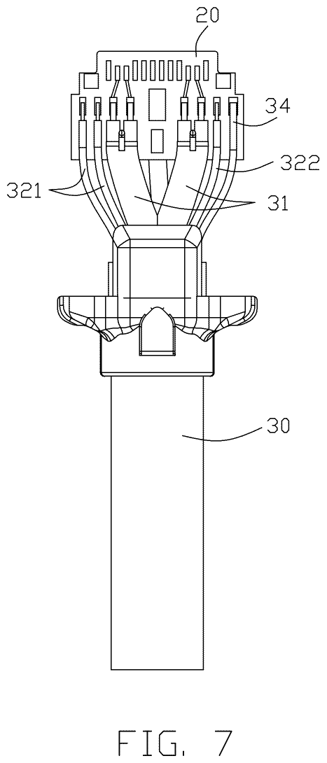

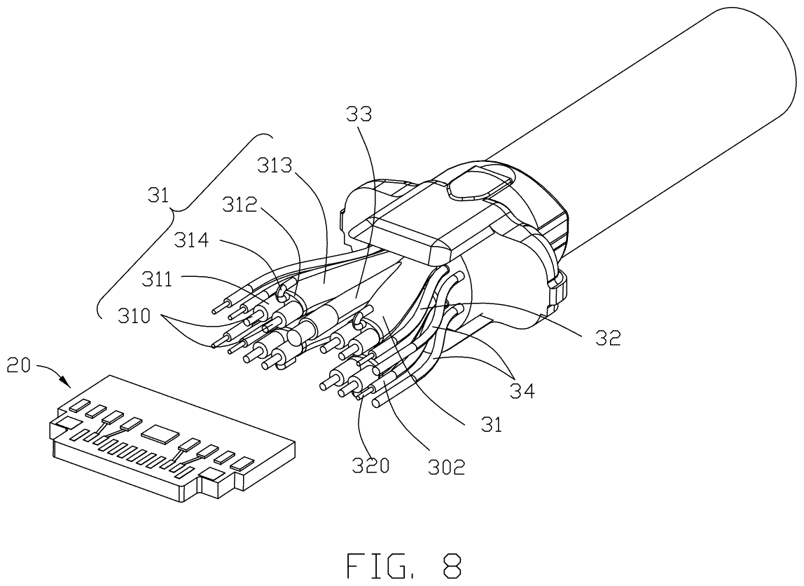

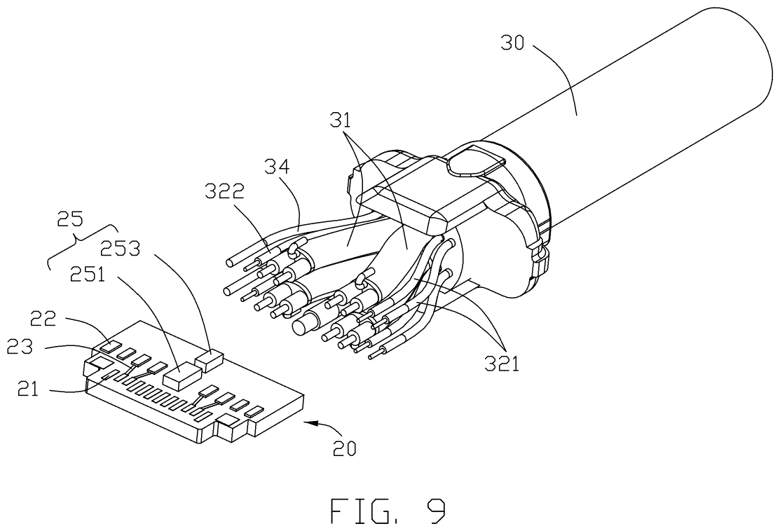

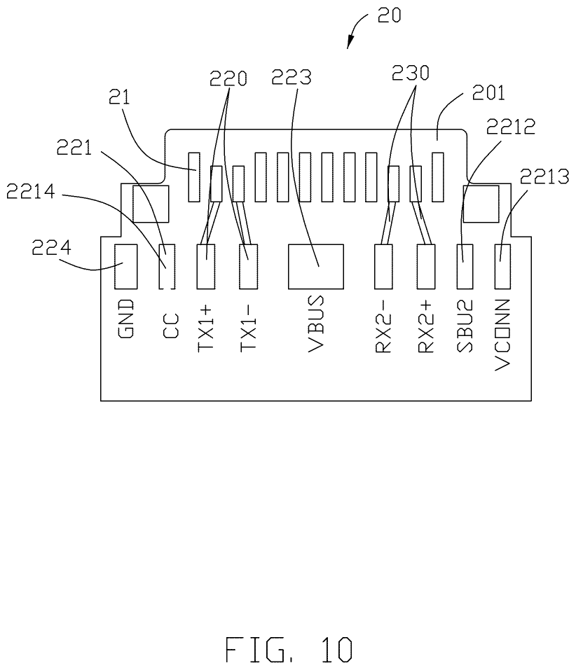

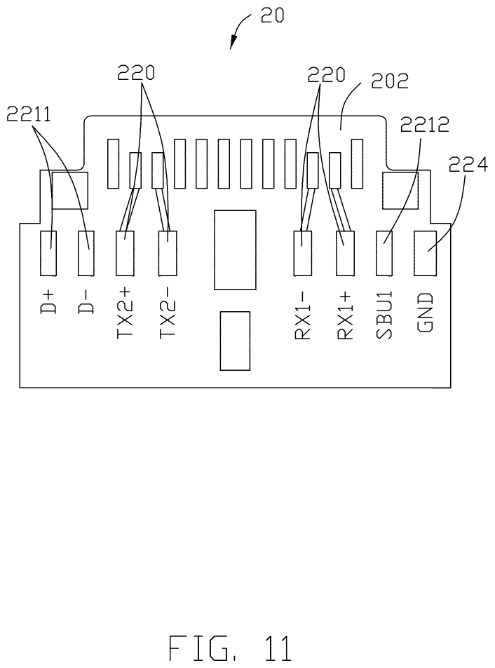

Referring to FIGS. 1-11, a cable connector assembly 100 in accordance with the present invention includes a mating plug 10 that can mate with a mating connector (not shown), a circuit board 20 electrically connected to the mating plug 10, a cable 30 electrically connected to the circuit board 20, a metal cage 40 installed on the mating plug 10 and the cable 30, a metal cage 40 installed on the mating plug 10 and the cable 30, an inner mold 50 covering the metal cage 40 and the front of the cable 30, and an insulative casing 60 covering the outside of the inner mold 50. The cable 30 is electrically connected to the mating plug 10 through the circuit board 20. The cable connector assembly 100 includes four high-speed channels, and the transmission speed of each channel can reach 10 Gbps or even higher.

The mating plug 10 includes an insulative housing 11, a plurality of conductive terminals 12 received in the insulating housing 11, and a metal shell 13 disposed outside the insulative housing 11. The conductive terminals 12 are arranged in two rows spaced apart in the vertical direction, and the conductive terminals 12 of each row are arranged at intervals in the transverse direction.

The cable 30 includes a plurality of high-speed wire 31 for transmitting high-speed signals, a plurality of low-speed wires 32 for transmitting low-speed signals, a power wire 33 (VBUS) for transmitting power, and a ground wire 34 (GND) for grounding. The low-speed wires include a pair of low-speed signal wires 321 (D+D−) for transmit USB2.0 signals, two auxiliary signal wires 322 (SUB1, SUB2) for transmitting audio signals, etc. as needed, a chip power supply wire 323 (VCONN) used to supply power to the chip on the circuit board 20, and a detection signal wire 324 (CC) used to determine the working status.

In the present invention, there are four high-speed wires 31 for transmitting four pairs of high-speed differential signals. Each of the high-speed wire 31 is coaxial wired and includes a pair of inner conductors 310, an inner insulation layer 311 covering the pair of inner conductors 310, a common shielding layer 312 covering the inner insulation layer 311, an outer sheath 313 covering the shielding layer 312, and a ground wire 314 adjacent to the shielding layer 312. The ground wire 314 is bent backward to contact the metal cage 40. The low-speed wire 32, the power wire 33 and the ground wire 34 are configured as single-core wires. Each single-core wire includes a conductor 320 and an insulation layer 302 covering the conductor 320.

The circuit board 20 includes a first face 201 and a second face 202 opposite to the first face 201. Each of the first face 201 and the second face 202 of the circuit board is provided with a plurality of terminal pad 21 for electrical connection with the corresponding conductive terminals 12, a plurality of cable pads 22 for connecting to the cable 30, and a plurality of conductive traces 23 connecting the corresponding terminal pads 21 and the cable pads 22. The cable pads 22 includes pairs of high-speed cable pads 220 for connecting to the high-speed wire 31, a plurality of low-speed cable pads 221 for connecting to the low-speed wire 32, a power cable pad 223 for connecting to the power wire 33, and a ground cable pad 224 for connecting to the ground wire 34.

The low-speed cable pads 221 includes a pair of low-speed signal cable pad 2211 for connecting to the low-speed signal wire 321, two auxiliary signal cable pads 2212 for connecting to the auxiliary signal wire 322, a chip power supply cable pad 2213 for connecting to the chip power supply wire 323, and a detection signal cable pad 2214 for connecting to the detecting signal wire 324. The conductive trace 23 includes pairs of high-speed conductive traces 230 connecting the corresponding high-speed cable pads 220 and the terminal pads 21.

Each pair of inner conductors 310 of the high-speed wire 31 are connected to the corresponding pair of high-speed cable pads 220 to form a pair of high-speed channels. On the first face 201, the power cable pad 223 is disposed in the middle area in the transverse direction, and is located between the two pairs of high-speed cable pads 220. The low-speed cable pad 221 and the ground cable pad 224 are respectively located outside the high-speed cable pads 220 in the transverse direction. Specifically, the ground cable pad 224 and the chip power supply cable pad 2213 are respectively disposed on the two outermost sides of the circuit board 20 in the transverse direction. The detection signal cable pad 2214 is adjacent to the ground cable pad 224, and the second auxiliary cable pad of the auxiliary signal cable pads 2212 is adjacent to the chip power supply cable pad 2213. Therefore, on the first face 201, the cable pads 22 are arranged laterally as GND, CC, TX1+, TX1−, VBUS, RX2−, RX2+, SBU1, VCONN.

On the second face 202, the low-speed cable pads 221 and the ground cable pad 224 are arranged outside the high-speed cable pads 220 in the transverse direction. Specifically, the pair of low-speed signal cable pads 2211 are provided on one side of the circuit board 20, and the ground cable pad 224 is provided on the other side of the circuit board 20. The first auxiliary cable pad of the auxiliary signal cable pads 2212 is disposed inside the ground cable pad 224. The ground cable pads 224 on the two face are arranged on the same side. Therefore, the cable pads 22 on the second face 202 are arranged laterally as D+, D−, TX2+, TX2− TX1+, RX2−, RX2+ SBU2, GND. There are electronic components 25 on the circuit board 20. The electronic components 25 are disposed on the second face 202 and are located between the row of cable pads 22 in the transverse direction. The width of the electronic component 25 is arranged along the transverse direction of the circuit board 20, and the length of the electronic component 25 is arranged along the front and rear direction of the circuit board 20. At least part of the electronic components 25 is disposed on the rear side of the cable pad 22. In the present invention, the electronic component 25 includes a chip 251 and a capacitor 253. The chip 251 and the cable pads 22 are arranged in a row, and the capacitor 253 is arranged on the rear side of the chip 251. The electronic components 25 separate the two pairs of high-speed channels.

The cable connector assembly 100 further includes a fixing block 70 integrally formed on the mating plug 10, the circuit board 20 and the cable 30. The fixed block 70 has a groove 701 for the capacitor 253. In the cable connector assembly 100 of the present invention, through the placement of the chip 251 and the capacitor 253, the relief groove 701 provided on the fixing block 70, and the arrangement of the cable pads 22, so that each pair of the high-speed cable pads 220 is connected to the nearest pair of terminal pads 21 to shorten the length of the high-speed conductive trace 230. In the present invention, the length of the high-speed conductive trace 230 is less than or equal to 1.0 mm, so that the attenuation can be reduced to −0.48 dB at the operating frequency of 15 GHz. The high-speed conductive trace 230 is configured as a straight line. Furthermore, the pair of high-speed conductive traces 230 have the same length and are axially symmetrically along an axis in the front-rear direction.

Each of the conductive terminals 12 is soldered to the corresponding terminal pad 21. Each core wire of the cable 30 is soldered to the corresponding cable pad 22. In order to protect the soldering area, the cable connector assembly 100 further includes a first glue portion 71 formed by a first glue located at the connection between the conductive terminal 12 and the terminal pad 21, a second glue portion 72 formed by a second glue that located at the connection between the cables 30 and the cable pads 22, and a third glue portion 73 formed by a third glue covering the first glue portion 71, the second glue portion 72 and the circuit board 20 between the first glue portion 71 and the second glue portion 72. At the connection between the high-speed wire 31 and the circuit board 20, in addition to the cable pads on the circuit board 20, the conductive material also includes the inner conductor 310 and the shielding layer 312 of the cable 30. Compared to the conductive material at the connection between the conductive terminal 12 and the circuit board are the conductive terminal 12 and the terminal pad. The conductive material at the connection between the cable 30 and the circuit board 20 is more than that at the connection between the conductive terminal 12 and the circuit board 20. Therefore, the impedance at the connection part of the cable 30 is lower, and the impedance at the connection part of the conductive terminal 12 is higher. In order to match the impedances of the two places, it is necessary to increase the impedance at the soldering area of cable 30, and reduce the impedance at the soldering area of the conductive terminal 12. In the present invention, the impedance at the two parts is adjusted through the selection and distribution of glues. Specifically, the first glue and the second glue are the same, and the third glue is different from the first glue and the second glue. The first glue and the second glue are UV glues with a dielectric constant of 4.6 and a dielectric constant change rate of 0.0393. The third glue is a hot melt adhesive with a dielectric constant of 2.1 and a dielectric constant change rate of 0.0001. In addition, the amount of glue placed at the soldering area between the cable 30 and the circuit board 20 is less than the glue at the soldering area between the conductive terminal 12 and the circuit board 20.

The cable pads 22 on the first face 201 and the second face 202 are arranged in a row in the transverse direction, so that the cables 30 can be soldered to the circuit board at one time, thereby improving production efficiency.

In the electrical connector assembly 100 of the present invention, each pair of the high-speed cable pads 220 is connected to the nearest pair of terminal pads 21, shortening the length of the high-speed conductive trace 230, thereby shortening the transmission distance of high-speed signals in the circuit board 20 and making it easy to achieve effective transmission of high-speed signals.

1. A cable connector assembly comprising:
a mating plug including a plurality of conductive terminals;
a circuit board being electrically connected to the mating plug and including:
a plurality of terminal pads located at a front of the circuit board and mechanically and electrically connected to the conductive terminals;
a plurality of cable pads located at a rear of the circuit board and including plural pairs of high-speed cable pads; and
a plurality of conductive traces each connecting a corresponding terminal pad and a corresponding cable pad; and
a cable mechanically and electrically connected to the cable pads; wherein the cable includes plural pairs of high-speed wires for transmitting high-speed signals, the conductive traces include plural pairs of high-speed conductive traces connecting the plural pairs of high-speed cable pads and corresponding terminal pads, each pair of high-speed cable pads are connected to a nearest pair of terminal pads.

2. The electrical connector assembly as claimed in claim 1, wherein a length of each high-speed conductive trace is not greater than 1.0 mm.

3. The electrical connector assembly as claimed in claim 1, wherein each of the plurality of high-speed conductive traces is a straight line.

4. The electrical connector assembly as claimed in claim 1, wherein the two conductive traces of each pair of high-speed conductive traces have same length.

5. The electrical connector assembly as claimed in claim 1, wherein the two conductive traces forming a pair of the high-speed conductive traces are arranged axially symmetrically.

6. The electrical connector assembly as claimed in claim 1, wherein the cable pads are arranged in a row along a transverse direction on the circuit board.

7. The electrical connector assembly as claimed in claim 6, further including plural electronic components mounted on the circuit board, and wherein the plural electronic components are disposed between the row of cable pads in the transverse direction, and at least some of the electronic components are disposed on a rear side of the cable pads.

8. The electrical connector assembly as claimed in claim 6, wherein a width direction of the electronic component is arranged along the transverse direction of the circuit board.

9. The electrical connector assembly as claimed in claim 6, wherein the cable further includes a low-speed wire and a ground wire, and the cable pads include a low-speed cable pad connected to the low-speed wire and a ground cable pad connected to the ground wire.

10. The electrical connector assembly as claimed in claim 9, wherein the low-speed cable pad and the ground cable pad are located outside the high-speed cable pads in the transverse direction.

11. The electrical connector assembly as claimed in claim 6, wherein the plurality of cable pads are arranged in a row in the transverse direction.

12. The electrical connector assembly as claimed in claim 1, further including a first glue portion located at the connection between the conductive terminal and the terminal pad, a second glue portion located at the connection between the cables and the cable pads, and a third glue portion covering the first glue portion, the second glue portion, and a part of the circuit board between the first glue portion and the second glue portion.

13. The electrical connector assembly as claimed in claim 12, wherein the first glue portion is formed by a first glue, the second glue portion is formed by a second glue, and the third glue portion is formed by a third glue.

14. The electrical connector assembly as claimed in claim 13, wherein the first glue and the second glue are same, and the third glue is different from the first glue and the second glue.

15. The electrical connector assembly as claimed in claim 13, wherein a dielectric constant of the first glue and the second glue is 4.6, and the dielectric constant of the third glue is 2.1.

16. The electrical connector assembly as claimed in claim 13, wherein the first glue and the second glue are UV glues, the third glue is a hot melt adhesive.

17. The electrical connector assembly as claimed in claim 13, wherein an amount of glue placed at a soldering area between the cable and the circuit board is less than an amount of glue placed at a soldering area between the conductive terminal and the circuit board.
